(19) United States
(12) Patent Application Publication
(10) Pub. No.: US 2005/0261009 A1
(43) Pub. Date: Nov. 24, 2005

(54) Encouraging traffic in a communications network

(76) Inventors: Todd Hertzberg, Dunedin, FL (US); Jens Benner, Copenhagen (DK); Povl Koch, Copenhagen (DK); Christian Kraft, Hvidovre (DK); Claus A. Pedersen, Copenhagen (DK)

Correspondence Address: PERMAN & GREEN, 425 POST ROAD, FAIRFIELD, CT, 06824, US

(21) Appl. No.: 10/848,286

(22) Filed: May 18, 2004

(51) Int. Cl. H04Q 7/20

(52) U.S. Cl. 455/466

(57) ABSTRACT

Traffic in a communication network is encouraged by providing a small advertisement service. Small advertisements are placed by subscribers and then broadcast to other subscribers to encourage some of the other subscribers to place a call to an advertising subscriber.

### FIELD OF THE INVENTION

The present invention relates to a method of encouraging use of a mobile communication network and an advertising system.

### BACKGROUND TO THE INVENTION

Generally, mobile phone network operators charge users per minute for phone calls and per message for SMS (short message service) messages. Therefore, revenues are tied to subscribers' needs and desires to engage in communication using their mobile phones. These needs and desires are generally determined by factors beyond the control of the network operator, for instance who a subscriber knows or is related to.

### SUMMARY OF THE INVENTION

An object of the present invention is to bring subscribers into relationships in which they wish to communicate using their mobile phones or the like.

According to the present invention, a method of encouraging use of a mobile communication network, the method comprising:
receiving a message;
transmitting said message, together with a network address identifying the first mobile station, to a plurality of mobile stations including a second mobile station; and
responding to signals from the second mobile station to establish a network connection between the first station and the second station.

Thus, the present invention can make subscribers aware that there is value in their communicating with each other. As a side effect, the network traffic increases and the network operator obtains an increase in revenue.

The message may be received in a short message service message, in a speech telephone call, an email, via web page form or by any other way.

In most embodiments, a plurality of messages will be received and their contents broadcast, for example in cell broadcast messages.

The messages may be received as short message service messages.

The network connections are conveniently speech-carrying channels, i.e. channels adapted for speech traffic.

The received message or messages may be analysed to ensure that only messages whose content is appropriate are broadcast. The received messages may also be classified and transmitted in cell broadcast channels selected on the basis of their classifications.

The messages may be advertisements. The advertisements are conveniently like the small advertisements found in local newspapers.

According to the present invention, there is also provide an advertising system comprising:
message receiving means for receiving messages from a short message service function of a mobile communication system;
message transmitting means for sending cell broadcast messages for said mobile communication system
a database; and
processing means,
wherein the processing means is configured to:
   store advertisement text, received by the message receiving, in the database,
   read stored advertisement text from the database, and
   transmit the read advertisement text, together with a network address of the source thereof, using the message transmitting means.

### BRIEF DESCRIPTION OF THE DRAWINGS

FIG. 1 is a block diagram of a mobile phone network implementing an embodiment of the present invention;

FIG. 2 is a block diagram illustrating the exchange of signals between an advertiser's mobile station and the small advertisement administration system shown in FIG. 1;

FIG. 3 is a flowchart illustrating an advertisement placement process; and

FIG. 4 is a flowchart illustrating an advertisement dissemination process.

### DETAILED DESCRIPTION OF EMBODIMENT

An embodiment of the present invention will now be described, by way of example, with reference to the accompanying drawings.

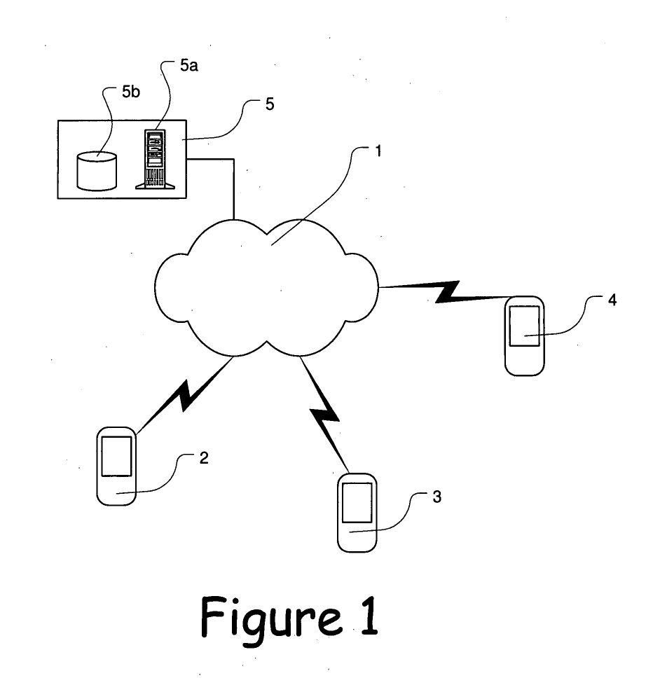

Referring to FIG. 1, a mobile phone network, implementing an embodiment of the present invention, comprises network infrastructure 1, which is well-known to the skilled person and includes mobile switching centers, base transceiver sites, base station controllers, etc., a plurality of conventional mobile stations 2, 3, 4, operated by first, second and third subscribers respectively, and a small advertisement administration system 5. The small advertisement administration system 5 includes a computer 5a which can communicate with the mobile stations 2, 3, 4 using the SMS facility of the mobile phone network and a database 5b.

The small advertisement administration system 5 may be implemented in an SMSC (short message service center) of the mobile phone network.

In the following, it is assumed that the subscriber associated with the first mobile station 2 has registered with the small advertisement administration system 5, either by sending an SMS message to a particular number or completing paper or electronic registration forms.

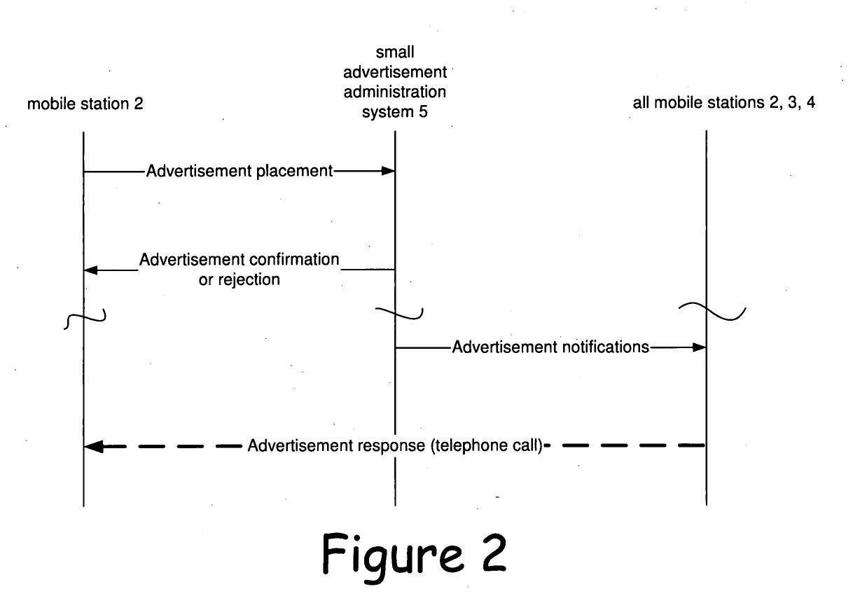

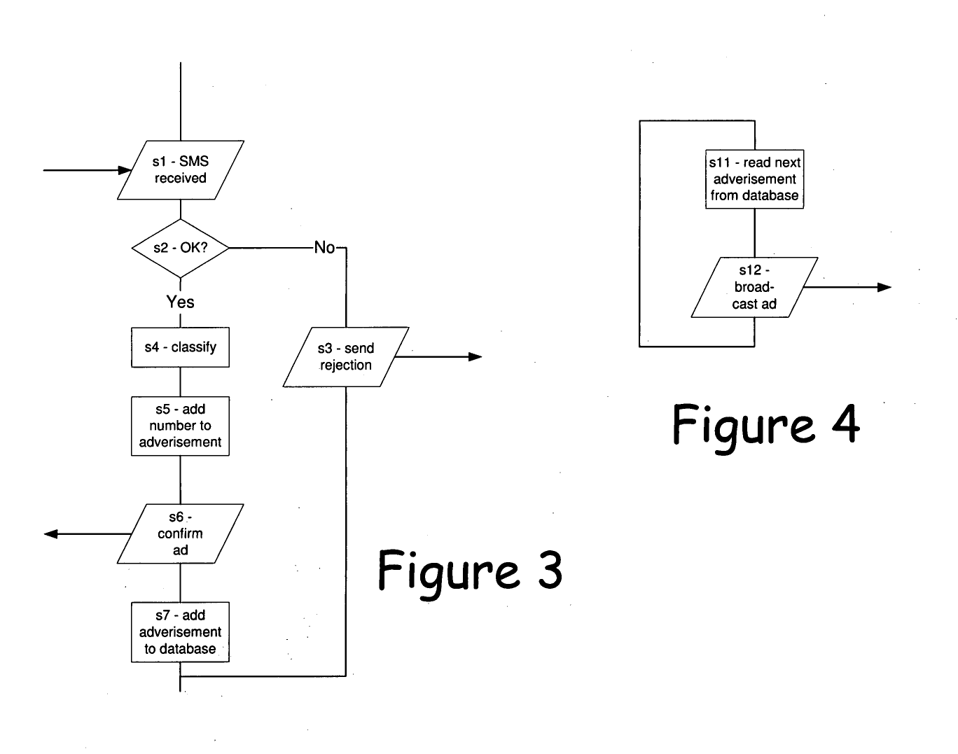

Referring to FIGS. 2 and 3, when the first subscriber wishes to place an advertisement, the first subscriber sends an advertisement placement SMS message to the small advertisement administration system 5. The message will contain the text of the advertisement, for example “For Sale, 1983 VW Beetle $1000” or “Wanted, Fender Telecaster”. Preferably, no network charges are made for the SMS to the small advertisement administration system 5.

The advertisement placement SMS message is received by the small advertisement administration system 5, step s1, and is then, vetted step s2, and classified, step s4. The vetting may be performed by a human operator or automatically by suitable software, which may operated in a similar manner to spam filtering software. The advertisement is classified according to its subject, e.g. “electronics”, “cars”, “furniture”, etc., and/or whether it is a “for sale” advertisement or a “wanted” advertisement. The aim of the vetting is to ensure that the advertiser is registered by reference to the database 5b and that the advertisement is legally and socially acceptable, and to ensure that the advertisement is transmitted in the correct channel.

If the advertisement is not acceptable in step s2, a rejection SMS message is sent to the would-be advertiser, step s3.

When an acceptable advertisement has been classified, step s3, the telephone number of the advertiser, obtained from the database 5b or the advertisement placement SMS, is added to the text of the advertisement placement SMS, step s5. The placing of the advertisement is then confirmed to the advertiser in an SMS message, step s6. The extended text is then stored in the database 5b, step s7.

Referring to FIG. 4, the advertisements, stored in the database 5a, are organised according to how the have been classified in step s4. The advertisements in each classification are cyclically read, step s11, and broadcast in cell broadcast messages, step s12. A different SMS broadcast channel is used for each advertisement classification.

Advertisements are given a predetermined lifetime and are deleted from the database 5b when their lifetimes have expired.

Referring back to FIG. 2, if another subscriber, for example the second or third subscribers, is interested in an advertisement, the interested subscriber calls the advertising subscriber, using the number included in the advertising cell broadcast message. The advertising and interested subscribers can then discuss the substance of the advertisement. This call is charged by the network to the interested party as the calling party.

The present invention has been described with reference to SMS messages and cell broadcast messages. However, it will be appreciated that other approaches may be adopted. For example, the WAP push could be used to deliver advertisements to subscribers. Also, the delivery of advertisements could be restricted to users who are registered as willing to receive such advertisements.

In other embodiments, the advertisements may be placed by making a speech call to a call center, sending an email or by means of a form in a web page to provide the advertisement text and information identifying the advertiser's mobile phone, e.g. the phone number or the subscriber's name or account number, instead of by sending an SMS message.

In the foregoing, terminology appropriate for GSM (Global System for Mobile Communications) mobile phone networks has been used. However, this is not intended to be limiting and the skilled person will understand that different terms may be applied in respect of other systems for equivalent functions.

The skilled person will appreciate that other modifications may be made to the above-described embodiment without departing from the spirit and scope of the claims.

1. A method of encouraging use of a mobile communication network, the method comprising:
receiving a message;
transmitting said message, together with a network address identifying a first mobile station, to a plurality of mobile stations including a second mobile station; and
responding to signals from the second mobile station to establish a network connection between the first station and the second station.

2. A method according to claim 1, including receiving a plurality of messages and storing the messages in a database and cyclically transmitting messages, stored in the database, to said plurality of mobile stations.

3. A method according to claim 1, wherein the transmitting of said message is effected by transmitting the message in a cell broadcast message.

4. A method according to claim 1, wherein the message received from the first mobile station is a short message service message.

5. A method according to claim 4, wherein the transmitting of said message is effected by transmitting the message in a cell broadcast message.

6. A method according to claim 1, wherein said network connection is a speech-carrying channel.

7. A method according to claim 6, wherein the message received from the first mobile station is a short message service message.

8. A method according to claim 6, wherein the transmitting of said message is effected by transmitting the message in a cell broadcast message.

9. A method according to claim 1, including analysing the received message and only transmitting the received message to a plurality of mobile stations if it meets predetermined criteria.

10. A method according to claim 1, wherein the message comprises an advertisement.

11. A method according to claim 3, including classifying said message and selecting a cell broadcast channel for said cell broadcast message in dependence on the classification of said message.

12. A method of encouraging use of a mobile communication network, the method comprising:
receiving a short message service message from a first mobile station via a mobile communication network;
transmitting at least part of the content of said message, together with a network address identifying the first mobile station, to a plurality of mobile stations, including a second mobile station, in a cell broadcast message; and
responding to signals from the second mobile station to establish a speech-carrying network connection between the first station and the second station.

13. A method according to claim 12, including analysing the received message and only transmitting the received message content to a plurality of mobile stations if it meets predetermined criteria.

14. A method according to claim 12, wherein the message comprises an advertisement.

15. A method according to claim 12, including classifying said message and selecting a cell broadcast channel for said cell broadcast message in dependence on the classification of said message.

16. A method of encouraging use of a mobile communication network, the method comprising:
receiving a plurality of messages;
transmitting said messages, together with network addresses identifying respective mobile stations, to a plurality of mobile stations; and
responding to signals from one of said plurality of mobile stations to establish a network connection between one of said sending station and said one of said plurality of mobile stations.

17. A method according to claim 16, including analysing the received messages and only transmitting the received messages to a plurality of mobile stations if they meet predetermined criteria.

18. A method according to claim 16, wherein the messages comprise advertisements.

19. A method of encouraging use of a mobile communication network, the method comprising:
receiving a plurality of short message service messages from mobile stations via a mobile communication network;
transmitting at least part of the content of each of said messages, together with network addresses identifying the respective sending mobile stations, to a plurality of mobile stations in cell broadcast messages; and
responding to signals from one of said plurality of mobile stations to establish a network connection between one of said sending station and said one of said plurality of mobile stations.

20. A method according to claim 19, including analysing the received messages and only transmitting the received messages to a plurality of mobile stations if they meet predetermined criteria.

21. A method according to claim 20, wherein the messages comprise advertisements.

22. A method according to claim 19, including classifying said messages and selecting cell broadcast channels for said cell broadcast messages in dependence on the classifications of said messages.

23. A method of encouraging use of a mobile communication network, the method comprising:
receiving an advertisement;
transmitting said advertisement, together with a network address identifying a first mobile station, to a plurality of mobile stations including a second mobile station; and
responding to signals from the second mobile station to establish a network connection between the first station and the second station.

24. A method according to claim 23, including receiving a plurality of advertisements via the mobile communication network and storing the advertisements in a database and cyclically transmitting advertisements, stored in the database, to said plurality of mobile stations.

25. A method according to claim 23, including analysing the received advertisements and only transmitting the received advertisements to a plurality of mobile stations if they meet predetermined criteria.

26. A method of encouraging use of a mobile communication network, the method comprising:
receiving an advertisement from a first mobile station in a short message service message via a mobile communication network;
transmitting said advertisement, together with a network address identifying the first mobile station, to a plurality of mobile stations including a second mobile station in a cell broadcast message; and
responding to signals from the second mobile station to establish a speech-carrying network connection between the first station and the second station.

27. A method according to claim 26, including receiving a plurality of advertisements in respective short message service messages via the mobile communication network and storing the advertisements in a database and cyclically transmitting advertisements, stored in the database, to said plurality of mobile stations.

28. A method according to claim 26, including analysing the received advertisements and only transmitting the received advertisements to a plurality of mobile stations if they meet predetermined criteria.

29. A method according to claim 26, including classifying the received advertisements and selecting cell broadcast channels for said cell broadcast messages in dependence on the classifications of said advertisements.

30. An advertising system comprising:
message receiving means for receiving advertisement text and mobile station identifying information associated therewith;
message transmitting means for sending cell broadcast messages for a mobile communication system
a database; and
processing means,
wherein the processing means is configured to:
store advertisement text, received by the message receiving means, in the database,
read stored advertisement text from the database, and
transmit the read advertisement text, together with a network address associated therewith, using the message transmitting means.

31. An advertising system according to claim 30, for receiving messages from a short message service function of a mobile communication system.

32. A method according to claim 26, including classifying the received advertisement texts and selecting cell broadcast channels for said cell broadcast messages in dependence on the classifications of said advertisement texts.
